(19) United States
(12) Patent Application Publication
(10) Pub. No.: US 2021/0183288 A1
(43) Pub. Date: Jun. 17, 2021

(54) LIGHT FIELD NEAR-EYE DISPLAY DEVICE AND METHOD OF LIGHT FIELD NEAR-EYE DISPLAY

(71) Applicant: Coretronic Corporation, Hsin-Chu (TW)

(72) Inventor: Chih Hung Lu, Hsin-Chu (TW)

(73) Assignee: Coretronic Corporation, Hsin-Chu (TW)

(21) Appl. No.: 17/123,080

(22) Filed: Dec. 15, 2020

Related U.S. Application Data
(60) Provisional application No. 62/948,811, filed on Dec. 17, 2019.

(30) Foreign Application Priority Data
Jul. 13, 2020 (CN) 202010668339.4

(51) Int. Cl. G09G 3/02; G02B 30/10

(52) U.S. Cl. CPC G09G 3/02; G09G 2320/0606; G09G 2340/14; G02B 30/10

(57) ABSTRACT

A light field near-eye display device and a method of light field near-eye display are provided. The light field near-eye display device includes a display, a processor, a lens array, and at least one lens. The display is configured to emit an image beam. The processor is electrically connected to the display, and configured to control a display content of the display. The lens array is disposed on a transmission path of the image beam. The lens is disposed between the display and an eye. The image beam is projected to the eye through the lens array and the lens, so as to form a light field virtual image. The processor is configured to receive aberration data of the eye which is input by the user and cause the light field virtual image to be formed in focus range corresponding to the aberration data of the eye.

### CROSS-REFERENCE TO RELATED APPLICATION

This application claims the priority benefit of U.S. provisional application Ser. No. 62/948,811, filed on Dec. 17, 2019 and China application serial no. 202010668339.4, filed on Jul. 13, 2020. The entirety of each of the above-mentioned patent applications is hereby incorporated by reference herein and made a part of this specification.

### BACKGROUND

### Technical Field

The disclosure relates to a display technology; particularly, the disclosure relates to a light field near-eye display device and a method of light field near-eye display.

### Description of Related Art

Ray tracing technology simulates paths of light rays, and graphics cards need to draw contact areas of the light rays. Although requirements is enhanced for the graphics cards, the technology also brings forth images which is more resembling the real world. Compared to the conventional rasterization technology, the ray tracing technology can realize more lifelike shadow and reflection effects, and improve translucency and scattering effects at the same time.

Currently, one of the display technologies that can solve vergence-accommodation conflict (VAC) is light field near-eye display (LFNED), which can be divided into two architectures: spatial multiplexing and temporal multiplexing. The temporal multiplexing architecture employs microelectromechanical system (MEMS) devices to change positions of virtual images and adjust foreground and background clarity. The spatial multiplexing architecture employs lens arrays to project corresponding parallax images on a panel; for example, lens arrays may be placed on organic light-emitting diode (OLED) displays to generate light field images.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

The disclosure provides a light field near-eye display device, which corrects an aberration of an eye of a user in the absence of wearing additional glasses.

In order to achieve one, some, or all of the above or other objectives, the embodiments of the disclosure provide a light field near-eye display device, which is configured to be disposed in front of an eye of a user. The light field near-eye display device includes a display, a processor, a lens array, and at least one lens. The display is configured to emit an image light beam. The processor is electrically connected to the display and is configured to control a display content of the display. The lens array is disposed on a transmission path of the image light beam and is located between the display and the eye. The at least one lens is disposed on the transmission path of the image light beam and is located between the display and the eye, where the image light beam is projected to the eye through the lens array and the at least one lens to form a light field virtual image. The processor is configured to receive aberration data of the eye which is input by the user, and form the light field virtual image within a focus range corresponding to the aberration data of the eye.

In order to achieve one, some, or all of the above or other objectives, the embodiments of the disclosure provide a method of light field near-eye display, which includes the following steps. Firstly, the light field near-eye display device is disposed in front of an eye of a user, where the light field near-eye display device includes a display, a lens array and at least one lens. The display is configured to emit an image light beam. The lens array is disposed on a transmission path of the image light beam and is located between the display and the eye. The at least one lens is disposed on the transmission path of the image light beam and is located between the display and the eye. The image light beam is projected to the eye through the lens array and the at least one lens to form a light field virtual image. Also, aberration data of the eye which is input by the user is received. Further, the light field virtual image is formed within a focus range corresponding to the aberration data of the eye.

Based on the foregoing, the embodiments of the disclosure have at least one of the following advantages or effects. In the light field near-eye display device and method in the disclosure, through the configuration of the lens array and the at least one lens, and through the processor receiving the aberration data of the eye of the user so that the light field virtual image is formed within the focus range corresponding to the aberration data of the eye, the aberration, such as myopia, hyperopia, presbyopia, or astigmatism, of the eye of the user can be corrected in the absence of wearing additional glasses.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of the configuration a light field near-eye display device according to an embodiment of the disclosure.

FIG. 2 is a flowchart of the steps executed by the processor in FIG. 1.

FIG. 3 is a schematic diagram of light ray data calculated for vision correction by the light field near-eye display device in FIG. 1.

FIG. 4 is a diagram of the relationship between an ability to focus of a human eye and a diopter.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

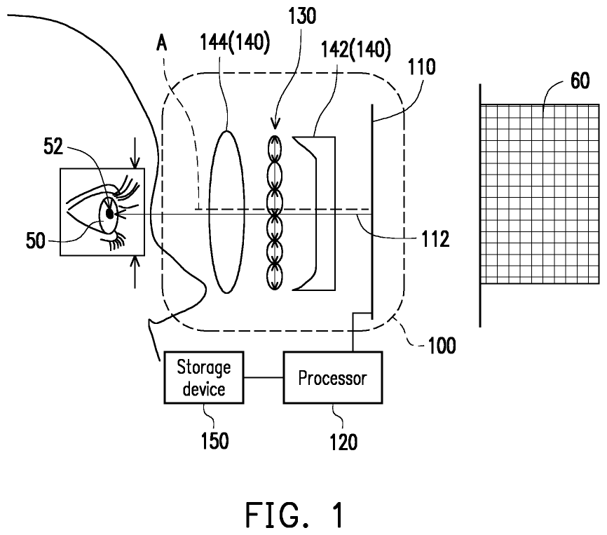

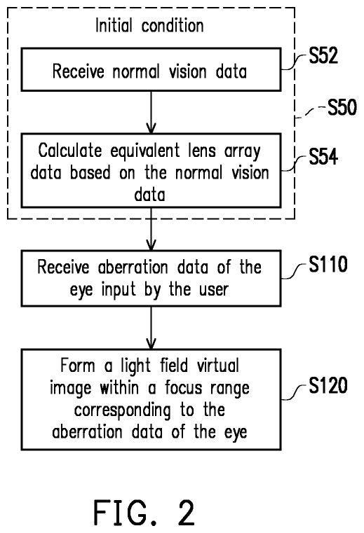

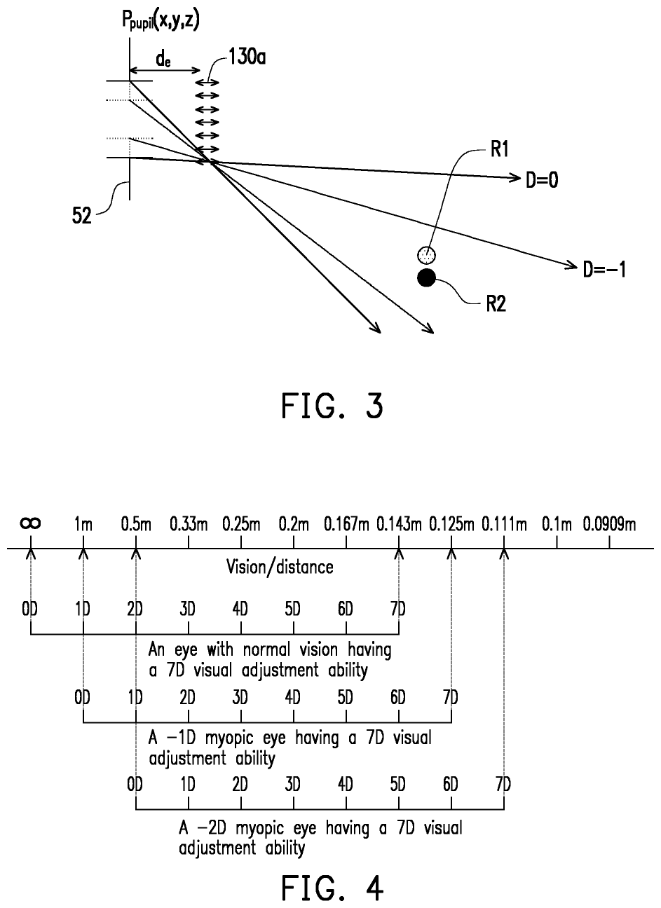

FIG. 1 is a schematic diagram of the configuration a light field near-eye display device according to an embodiment of the disclosure. FIG. 2 is a flowchart of the steps executed by the processor in FIG. 1. FIG. 3 is a schematic diagram of light ray data calculated for vision correction by the light field near-eye display device in FIG. 1. Refer to FIG. 1 to FIG. 3 firstly, a light field near-eye display device 100 in this embodiment is configured to be disposed in front of an eye 50 of a user. The light field near-eye display device 100 includes a display 110, a processor 120, a lens array 130, and at least one lens 140 (a plurality of lenses 140 are taken as an example in FIG. 1). The display 110 is configured to emit an image light beam 112. The processor 120 is electrically connected to the display 110, and is configured to control a display content of the display 110. The display 110 may be, for example, an organic light emitting diode display, a liquid crystal display, a micro light emitting diode display, or other suitable displays. The lens array 130 is disposed on a transmission path of the image light beam 112 and is located between the display 110 and the eye 50. In this embodiment, the lens array 130 is a micro lens array. The lenses 140 are disposed on the transmission path of the image light beam 112 and is located between the display 110 and the eye 50. The image light beam 112 is projected to the eye 50 through the lens array 130 and the lenses 140 to form a light field virtual image 60.

In this embodiment, the lenses 140 include a first lens 142 and a second lens 144. The lens array 130 is disposed between the first lens 142 and the second lens 144, and the first lens 142 is disposed between the display 110 and the lens array 130.

The processor 120 is configured to perform the following steps. First, step S52 is executed for normal vision data to be received. In this embodiment, the normal vision data is, for example, data for a diopter being zero, namely data for vision being OD. Herein, OD refers to zero diopter (0 diopter), namely a degree of myopia being 0, or no myopia. Specifically, the data for the vision being OD includes light ray data for OD normal vision in spatial multiplexing, which includes a starting position Pₚᵤₚᵢₗ(x,y,z) (unit: millimeter (mm)) of an inverse ray tracing from a pupil 52, a display position Pₚₐₙₑₗ(a,b) (unit: millimeter (mm)) of a light ray corresponding to the display 110, a unit vector [symbol] (X Y,Z) of the light ray advancing from Pₚᵤₚᵢₗ (x, y, z) to Pₚₐₙₑₗ(a, b), and a distance dₑ from an equivalent lens array 130a to the pupil 52.

Next, step S54 is executed to calculate equivalent lens array data based on the normal vision data. The lenses 140 and the lens array 130 can be equivalent to the equivalent lens array 130a. The equivalent lens array data includes a position Pₘ(x, y, z) of the equivalent lens array 130a. Specifically, according to the light ray data, the position Pₘ(x, y, z) of the equivalent lens array 130a can be calculated from Formula 1 below.

$${P}_{m} ( x , y , z ) = {P}_{p u p i l} ( x , y , z ) + \vec{V} ( X , Y , Z ) \times \frac{{d}_{e} \text{/} 1000}{\vert \vec{V} ( Z ) \vert} \qquad Formula 1$$

In Formula 1, | [symbol] (Z)| represents the length of a component of [symbol] (X,Y,Z) in a z direction. In this embodiment, the z direction is parallel to an optical axis A of the lenses 140, an x direction and a y direction are both perpendicular to the optical axis A, and the x direction is perpendicular to the y direction.

In this embodiment, the equivalent lens array data, after being calculated, may be stored in a storage device 150 to be directly retrieved from the storage device 150 in subsequent operations instead of recalculating the equivalent lens array data. Therefore, step S52 and step S54 may constitute an initial condition S50 of the light field near-eye display device, and the processor 120 may perform subsequent operations based on the initial condition S50.

Then, step S110 is executed to receive aberration data of the eye which is input by the user. In this embodiment, the aberration data of the eye includes a degree of myopia or a degree of hyperopia, a degree of astigmatism, a direction of astigmatism, or a combination thereof with regard to the eye 50. The aberration data of the eye can be input through an input interface (e.g., a button, a keyboard, or a touch screen) disposed on the light field near-eye display device 100 or through an electronic device (e.g., a computer or mobile phone, etc.) connected to the light field near-eye display device 100 as an input interface. Next, step S120 is executed to form the light field virtual image 60 within a focus range corresponding to the aberration data of the eye, so that the user having a visual ability corresponding to the aberration data of the eye can focus clearly. Furthermore, step S120 may include readjusting a plurality of coordinates of the pupil 52 of the eye 50 corresponding to the equivalent lens array data according to the equivalent lens array data of the lens array 130 and the lenses 140 calculated based on the normal vision data and the aberration data of the eye, that is, readjusting the starting position of the inverse ray tracing from the pupil 52 for each ray. Specifically, the processor 120 is configured to multiply coordinates of the pupil 52 in two directions perpendicular to the optical axis A of the lenses 140 by a proportionality constant (e.g., to multiply both the x-coordinate and the y-coordinate by the scaling parameter S), to readjust the plurality of coordinates of the pupil 52 corresponding to the equivalent lens array data. The proportionality constant is calculated based on the degree of myopia or the degree of hyperopia.

Specifically, the proportionality constant is the scaling parameter S which is adjusted with reference to a diopter of aberration of the user, where S is defined as the following formula 2.

$$S = \frac{1 \text{/} ( {F}_{0} + {F}_{c o r r e c t i o n} )}{1 \text{/} {F}_{0}} \qquad Formula 2$$

In Formula 2, F₀ represents a predetermined focal length (herein set to 3 meters), F_{correction} represents a focal length after vision correction, and given that the diopter is equal to the reciprocal of the focal length, S is defined as the ratio of the corrected vision diopter divided by the predetermined diopter. In other words, according to the degree of myopia (or hyperopia), which corresponds to the diopter, F_{correction} can be known, and then the scaling parameter S can be calculated according to F₀ and F_{correction}.

Pₚᵤₚᵢₗ(x,y,z) can be scaled according to the scaling parameter S to obtain a scaled starting position P′ₚᵤₚᵢₗ(x,y,z) of an inverse ray tracing from the pupil 52, as described in Formula 3 as follows.

P′ₚᵤₚᵢₗ(x,y,z)=Pₚᵤₚᵢₗ(x×S,y×S,z) Formula 3

In this embodiment, the storage device 150 is configured to store the equivalent lens array data calculated based on the normal vision data. The processor 120 retrieves the equivalent lens array data from the storage device 150, and readjusts the plurality of coordinates of the pupil 52 of the eye corresponding to the equivalent lens array data according to the aberration data of the eye. In this embodiment, the storage device 150 may be, for example, flash memory, random access memory, a hard disk, an optical disk, or other suitable memory or storage devices.

Afterward, step S120 may further include redesignating a plurality of light ray vectors incident into the plurality of coordinates of the pupil 52 of the eye 50 according to the plurality of coordinates of the pupil 52 of the eye 50 which are readjusted and the equivalent lens array data. That is, specifically, recalculating a unit vector [symbol] (X,Y,Z) (i.e., the light ray vector) of the light ray data of each point, as shown in Formula 4 below, of which the result is directions of the broken-line arrows as shown in FIG. 3.

[symbol]

(X,Y,Z)=Norm(Pₘ(x,y,z)−P′ₚᵤₚᵢₗ(x,y,z)) Formula 4

In Formula 4, Norm represents a normalization of the calculation result within the parentheses thereafter.

In this embodiment, the processor 120 is configured to determine a content of a light field virtual image at an intersection of a straight line drawn along each light ray vector (i.e., the unit vector [symbol] (X,Y,Z)) and the light field virtual image 60 and command a pixel of the display 110 corresponding to the light ray vector to display the content. Specifically, the starting position Pₚᵤₚᵢₗ(x,y,z) of the inverse ray tracing from the pupil 52 and the unit vector \vec{V}(X,Y,Z) (e.g., along a direction of a solid-line arrow annotated with D=0 in FIG. 3) of the light ray data are adjusted to be the scaled starting position P′ₚᵤₚᵢₗ(x,y,z) of the inverse ray tracing from the pupil 52 and the unit vector [symbol] (X,Y,Z) (i.e., the light ray vector, such as along a direction of the broken-line arrow annotated with D=−1 as shown in FIG. 3). Afterward, a new vector (i.e., the unit vector V′(X,Y,Z)) is employed to hit the same three-dimensional scene object (such as dots R1 and R2 in FIG. 3) when performing a ray tracing, and then data of the three-dimensional scene object is provided to the same display position Pₚₐₙₑₗ(a,b) to generate equivalent parallax. This method may be applicable to a spatial multiplexing light field display (e.g., the light field near-eye display device 100 in this embodiment that employs the lens array 130 to generate light field images), where a vision correction function can be achieved by adjusting the display content.

In this embodiment, the processor 120 may further be configured to perform a first coordinate rotation for the plurality of coordinates of the pupil 52 according to an astigmatism direction of the eye 50, by which one coordinate (e.g., an x-coordinate or a y-coordinate) of the coordinates in the two directions perpendicular to the optical axis A of the lenses 140 is rotated to the direction of astigmatism to form a coordinate to be adjusted. Then, the processor 120 multiplies the coordinate to be adjusted by a proportionality constant (i.e., a coefficient S′), which proportionality constant is calculated according to an astigmatism degree. After the coordinate to be adjusted is multiplied by the proportionality constant, the processor 120 performs a second coordinate rotation to restore the plurality of coordinates to their original directions, thereby completing readjusting the plurality of coordinates of the pupil 52 corresponding to the equivalent lens array data. Herein, a direction of second coordinate rotation is opposite to a direction of first coordinate rotation.

Specifically, the light field near-eye display device 100 may also choose whether to compensate for a regular astigmatism, one of the low order aberrations, of the eye 50, namely readjusting the starting position Pₚᵤₚᵢₗ(x,y,z) of the inverse ray tracing from pupil 52 of the light ray data. Step S110 and step S120 may include inputting regular astigmatism data, and calculating a new starting position of the inverse ray tracing from the pupil 52 through rotating all the coordinates of the pupil 52 by a rotation angle θ. P′_{pupil_temp}(x, y, z) at a transient state (i.e., when the coordinate is rotated to form the coordinate to be adjusted) can be calculated by Formula 5, where θ is an angle of regular astigmatism. The processor 120 multiplies the y-axis coordinate by the coefficient S′ (i.e., the proportionality constant) indicating an extent of astigmatism, and then obtains a final starting position P′_{pupil_final}(x,y,z) of an inverse tracing from the pupil 52 by rotating back to the original coordinate axis by Formula 6. Then, the manner in which the unit vector [symbol] (X,Y,Z) is recalculated through P′_{pupil_final}(x,y,z) and a position of the equivalent lens array 130a is similar to Formula 4. That is, [symbol] (X,Y,Z) is calculated by substituting P′_{pupil_final}(x,y,z) for P′ₚᵤₚᵢₗ(x,y,z) in Formula 4. Finally, through [symbol] (X,Y,Z) thus calculated, the processor 120 determines the content of the light field virtual image at the intersection of the straight line drawn along each light ray vector (i.e., the unit vector [symbol] (X,Y,Z)) and the light field virtual image 60 and commands the pixel of the display 110 corresponding to the light ray vector to display the content. Accordingly, the light field near-eye display device 100 can display the light field virtual image 60 after a regular astigmatism correction.

P′_{pupil_temp}(x,y,z)=Pₚᵤₚᵢₗ(x cos θ−y sin θ,(x sin θ+y cos θ)×S′,z) Formula 5

P′_{pupil_final}(x,y,z)=P′_{pupil_temp}(x cos(−θ)−y sin(−θ),x sin(−θ)+y cos(−θ),z) Formula 6

In an embodiment, the processor 120 may be, for example, a central processing unit (CPU), a microprocessor, a digital signal processor (DSP), a programmable controller, a programmable logic device (PLD), or other similar devices or a combination thereof. The disclosure is not limited thereto. In addition, in an embodiment, the functions of the processor 120 may be implemented as a plurality of program codes. The program codes are stored in memory, and are executed by the processor 120. Alternatively, in an embodiment, the functions of the processor 120 may be implemented as one or more circuits. The disclosure does not limit whether the implementation of the functions of the processor 120 is via software or hardware.

FIG. 4 is a diagram of the relationship between an ability to focus of a human eye and a diopter. Referring to FIG. 1 and FIG. 4, the diopter is a unit of measurement of refractive power of a lens or a curved mirror, and is equal to the reciprocal of a focal length f, usually represented by φ. That is, f=1/φ. Assuming that an eye having normal vision has a 7D ability to focus, namely a 7D visual adjustment ability, then the vision can focus clearly with a range from 0.143 meter (m) to infinity, and the most comfortable viewing distance (i.e., the distance of distinct vision) is near the 4D area (i.e., the middle area), which is about 0.25 m. In the case of myopia vision (e.g., vision being −1D, −2D . . . and so on), an interval of the 7D vision adjustment ability moves to the right. For example, a focus range of a user whose vision is −1D (i.e., −1.00 diopter of myopia) is 0.125 m to 1 m. Therefore, if the light field near-eye display device 100 places the light field virtual image 60 within the focus range of the myopic eye, then the user having such visual ability can focus clearly. By analogy, a focus range of a user whose vision is −2D (i.e., −2.00 diopters of myopia) is 0.5 m to 0.111 m.

Referring to FIG. 1 and FIG. 2 again, an embodiment of the disclosure also proposes a method of light field near-eye display, which can be implemented by the light field near-eye display device 100. The method of light field near-eye display may execute steps S110 and S120 of FIG. 2 by the processor 120, or it may as well execute all the tasks executed by the processor 120 in the foregoing embodiments. Alternatively, steps S52 and S54 in FIG. 2 may also be executed. In addition, before step S110 or step S52 is executed, the method of light field near-eye display may further include disposing the light field near-eye display device 100 in front of the eye 50 of the user, so that subsequent steps can be executed smoothly. For details of the step of the method of light field near-eye display, reference can be made to the details described in the foregoing embodiments of the light field near-eye display device 100, and will not be repeated herein.

In summary of the foregoing, in the light field near-eye display device and method in the embodiments of the disclosure, through the configuration of the lens array and the at least one lens, and through the processor receiving the aberration data of the eye of the user so that the light field virtual image is formed within the focus range corresponding to the aberration data of the eye, the aberration, such as myopia, hyperopia, presbyopia, or astigmatism, of the eye of the user can be corrected in the absence of wearing additional glasses. Moreover, the light field near-eye display device and method in the embodiments can also achieve the effect of correcting the low order aberration (such as regular astigmatism) in the absence of wearing additional glasses.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A light field near-eye display device configured to be disposed in front of an eye of a user and comprising a display, a processor, a lens array, and at least one lens, wherein:
the display is configured to emit an image light beam;
the processor is electrically connected to the display and is configured to control a display content of the display;
the lens array is disposed on a transmission path of the image light beam and is located between the display and the eye; and
the at least one lens is disposed on the transmission path of the image light beam and is located between the display and the eye, wherein the image light beam is projected to the eye through the lens array and the at least one lens to form a light field virtual image, wherein
the processor is configured to receive aberration data of the eye which is input by the user and form the light field virtual image within a focus range corresponding to the aberration data of the eye.

2. The light field near-eye display device according to claim 1, wherein the processor is configured to:
readjust a plurality of coordinates of a pupil of the eye corresponding to equivalent lens array data of the lens array and the at least one lens calculated based on normal vision data according to the equivalent lens array data and the aberration data of the eye; and
redesignate a plurality of light ray vectors incident into the plurality of coordinates of the pupil of the eye according to the plurality of coordinates of the pupil of the eye which are readjusted and the equivalent lens array data.

3. The light field near-eye display device according to claim 2, wherein the processor is configured to determine a content of the light field virtual image at an intersection of a straight line drawn along each of the plurality of light ray vectors and the light field virtual image and command a pixel of the display corresponding to each of the plurality of light ray vectors to display the content.

4. The light field near-eye display device according to claim 2, further comprising a storage device configured to store the equivalent lens array data calculated based on the normal vision data, wherein the processor retrieves the equivalent lens array data from the storage device and readjusts the plurality of coordinates of the pupil of the eye corresponding to the equivalent lens array data according to the aberration data of the eye.

5. The light field near-eye display device according to claim 4, wherein the processor is configured to:
receive the normal vision data; and
calculate the equivalent lens array data based on the normal vision data and store the equivalent lens array data in the storage device.

6. The light field near-eye display device according to claim 1, wherein the aberration data of the eye comprises a degree of myopia or a degree of hyperopia, a degree of astigmatism, a direction of astigmatism, or a combination thereof.

7. The light field near-eye display device according to claim 2, wherein the aberration data of the eye comprises a degree of myopia or a degree of hyperopia, a degree of astigmatism, a direction of astigmatism, or a combination thereof, and the processor is configured to:
multiply coordinates of the pupil in two directions perpendicular to an optical axis of the at least one lens by a proportionality constant to readjust the plurality of coordinates of the pupil corresponding to the equivalent lens array data, wherein the proportionality constant is calculated based on the degree of myopia or the degree of hyperopia.

8. The light field near-eye display device according to claim 2, wherein the aberration data of the eye comprises a degree of myopia or a degree of hyperopia, a degree of astigmatism, a direction of astigmatism, or a combination thereof, and the processor is configured to:
perform a first coordinate rotation for the plurality of coordinates of the pupil according to the direction of astigmatism, whereby a coordinate in two directions perpendicular to an optical axis of the at least one lens is rotated to the direction of astigmatism to form a coordinate to be adjusted;
multiply the coordinate to be adjusted by a proportionality constant, wherein the proportionality constant is calculated based on the degree of astigmatism; and
perform a second coordinate rotation, after multiplying the coordinate to be adjusted by the proportionality constant, to restore the plurality of coordinates to original directions to complete readjusting the plurality of coordinates of the pupil corresponding to the equivalent lens array data, wherein a direction of the second coordinate rotation is opposite to a direction of the first coordinate rotation.

9. The light field near-eye display device of claim 1, wherein the at least one lens comprises a first lens and a second lens, wherein the lens array is disposed between the first lens and the second lens, and the first lens is disposed between the display and the lens array.

10. A method of light field near-eye display comprising:
disposing a light field near-eye display device in front of an eye of a user, the light field near-eye display device comprising a display, a lens array and at least one lens, wherein the display is configured to emit an image light beam, the lens array is disposed on a transmission path of the image light beam and is located between the display and the eye, the at least one lens is disposed on the transmission path of the image light beam and is located between the display and the eye, and the image light beam is projected to the eye through the lens array and the at least one lens to form a light field virtual image;
receiving aberration data of the eye which is input by the user; and
forming the light field virtual image within a focus range corresponding to the aberration data of the eye.

11. The method of light field near-eye display according to claim 10, further comprising:
readjusting a plurality of coordinates of the pupil of the eye corresponding to equivalent lens array data of the lens array and the at least one lens calculated based on normal vision data according to the equivalent lens array data and the aberration data of the eye; and
redesignating a plurality of light ray vectors incident into the plurality of coordinates of the pupil of the eye according to the plurality of coordinates of the pupil of the eye which are readjusted and the equivalent lens array data.

12. The method of light field near-eye display according to claim 11, further comprising determining a content of the light field virtual image at an intersection of a straight line drawn along each of the plurality of light ray vectors and the light field virtual image and commanding a pixel of the display corresponding to each of the plurality of light ray vectors to display the content.

13. The method of light field near-eye display according to claim 11, further comprising:
storing the equivalent lens array data calculated based on the normal vision data by a storage device; and
retrieving the equivalent lens array data from the storage device and readjusting the plurality of coordinates of the pupil of the eye corresponding to the equivalent lens array data according to the aberration data of the eye.

14. The method of light field near-eye display according to claim 13, further comprising:
receiving the normal vision data; and
calculating the equivalent lens array data based on the normal vision data and storing the equivalent lens array data in the storage device.

15. The method of light field near-eye display according to claim 10, wherein the aberration data of the eye comprises a degree of myopia or a degree of hyperopia, a degree of astigmatism, a direction of astigmatism, or a combination thereof.

16. The method of light field near-eye display according to claim 11, wherein the aberration data of the eye comprises a degree of myopia or a degree of hyperopia, a degree of astigmatism, a direction of astigmatism, or a combination thereof, and the method of light field near-eye display further comprises:
multiplying coordinates of the pupil in two directions perpendicular to an optical axis of the at least one lens by a proportionality constant to readjust the plurality of coordinates of the pupil corresponding to the equivalent lens array data, wherein the proportionality constant is calculated based on the degree of myopia or the degree of hyperopia.

17. The method of light field near-eye display according to claim 11, wherein the aberration data of the eye comprises a degree of myopia or a degree of hyperopia, a degree of astigmatism, a direction of astigmatism, or a combination thereof, and the method of light field near-eye display further comprises:
performing a first coordinate rotation for the plurality of coordinates of the pupil according to the direction of astigmatism, whereby a coordinate in two directions perpendicular to an optical axis of the at least one lens is rotated to the direction of astigmatism to form a coordinate to be adjusted;
multiplying the coordinate to be adjusted by a proportionality constant, wherein the proportionality constant is calculated based on the degree of astigmatism; and
performing a second coordinate rotation, after multiplying the coordinate to be adjusted by the proportionality constant, to restore the plurality of coordinates to original directions to complete readjusting the plurality of coordinates of the pupil corresponding to the equivalent lens array data, wherein a direction of the second coordinate rotation is opposite to a direction of the first coordinate rotation.

18. The method of light field near-eye display according to claim 10, wherein the at least one lens comprises a first lens and a second lens, wherein the lens array is disposed between the first lens and the second lens, and the first lens is disposed between the display and the lens array.
